(19) United States
(12) Patent Application Publication
(10) Pub. No.: US 2016/0068418 A1
(43) Pub. Date: Mar. 10, 2016

(54) METHOD FOR ENHANCING DEGRADATION OF CHLORINATED ORGANICS

(71) Applicants: Ku-Fan Chen, Nantou (TW); Kuan-Yu Liu, Nantou (TW); Yu-Chen Chang, Nantou (TW)

(72) Inventors: Ku-Fan Chen, Nantou (TW); Kuan-Yu Liu, Nantou (TW); Yu-Chen Chang, Nantou (TW)

(73) Assignee: NATIONAL CHI NAN UNIVERSITY, Nantou County (TW)

(21) Appl. No.: 14/482,940

(22) Filed: Sep. 10, 2014

(51) Int. Cl. C02F 1/72; C02F 1/68

(52) U.S. Cl. CPC C02F 1/722; C02F 1/68; C02F 2103/34

(57) ABSTRACT

A method for raising pH value to enhance degradation of chlorinated organics by oxidation may include steps of adding 1% persulfate and 20-100 g slag to 50 mg/L chlorinated organics; and utilizing slag to increase the pH to 12-13, and make persulfate alkali-activated to enhance the degradation of chlorinated organics and prevent heavy metal pollute the soil.

### FIELD OF THE INVENTION

The present invention is related to degradation by persulfate oxidation, which can specifically increase degradation efficiency and a simple controlled method to raise pH and enhance degradation of chlorinated organics by oxidation.

### BACK GROUND OF THE INVENTION

Soil and ground water contamination problem is more severe and widespread than before. Pollution is mostly due to industrial wastewater and industrial waste. The chemical compound 1,2-dichloroethane (1,2-DCA) is an chlorinated organics. It is a colorless liquid with a chloroform-like odor. 1,2-dichloroethane is mainly used to as a solvent for wax, fat, and rubber. It is used to produce vinyl chloride (VC) and polycarbonate (PC). 1,2-Dichloroethane is permeable, fat-soluble, volatile, and carcinogenic and has long residual period. When the water source is polluted by chlorinated organics, we used to break contamination by oxidation. The oxidants include hydrogen peroxide, permanganate, persulfate and ozone. Using persulfate as an oxidant is a new process. In comparison with other oxidants, persulfate has high chemical activity, stable, and seldom react with solid organic matter, which has better durability and affect to subsurface. However, persulfate has low degradation rate and long degradation time. According to the result of experiment, adding 1% persulfate to 50 mg/L chlorinated organics (1,2-dichloroethane) takes 120 hours to remove 90% of chlorinated organics, which is obviously not efficient enough.

Due to different water flow rate, water volume, pollution concentration and polluted area, it is harder to degrade chlorinated organics in river or underground water. Generally, we increase persulfate rapidly, add activator like ferrous, or add sodium hydroxide prevent heavy metal pollute the soil under acidic condition, Whereas sodium hydroxide is expensive, above-mentioned methods are not easy controlled, even increase additional budget. Using persulfate to degrade chlorinated organics has the problems of not easy controlled, high cost, and long oxidative degradation time, which are the problems we want to improve in this invention.

Therefore, there remains a need for a new and improved invention to overcome the problems stated above.

### SUMMARY OF THE INVENTION

To solve the problems stated above, the present invention is raising pH level to enhance degradation of chlorinated organics by oxidation.

The present invention is raising pH level to enhance degradation of chlorinated organics by in situ chemical oxidation. Adding 1% persulfate and 20-100 g slag to 50 mg/L chlorinated organics, which utilize slag to increase the polluted water pH to 12-13, and make persulfate alkali-activated to enhance the degradation of chlorinated organics and prevent heavy metal pollute the soil.

Wherein the persulfate is sodium persulfate (Na₂S₂O₈).

Wherein the slag is basic oxygen furnace slag (BOF).

Wherein the slag is proportional mixing of basic oxygen furnace slag and ground granulated blast-furnace slag.

Wherein the chlorinated organics is 1,2-dichloroethane, which can be removed 90% after 96 hours by persulfate alkali activation at pH 12, and 94% after 72 hours by persulfate alkali activation at pH 13.

Wherein slag can be uniformly released to polluted water and took out after degradation oxidative degradation. It can decrease the possibility of secondary pollution.

The present invention focuses on utilizing slag to increase polluted water pH to 12-13 and make persulfate alkali-activated to enhance the degradation of chlorinated organics. Monitoring polluted water's pH level can coordinate different water flow rate, water volume, pollution concentration, and pollution area with proportional mixing of slag and adjust the ratio between persulfate and slag to control pH between 12-13. Whereby, it can increase organochloride degradation, decrease the cost, simple control, eliminate oxidative degradation time and overcome the problems stated above.

Other goal, advantages and characteristic of the present invention will be illustrated by a number of embodiments along with the descriptions and drawings.

### BRIEF DESCRIPTION OF THE DRAWINGS

FIG. 1 illustrates different quantities of slag degrade 1,2-dichloroethane of present invention.

FIG. 2 illustrates the releasing slag uniform of present invention.

FIG. 3 illustrates a 1,2-dichloroethane calibration curve plot of present invention.

FIG. 4 illustrates degradation of 1,2-dichloroethane under different pH conditions of present invention.

FIG. 5 illustrates the reaction rate of removing 1,2-dichloroethane under different pH conditions of present invention.

### DETAILED DESCRIPTION OF THE INVENTION

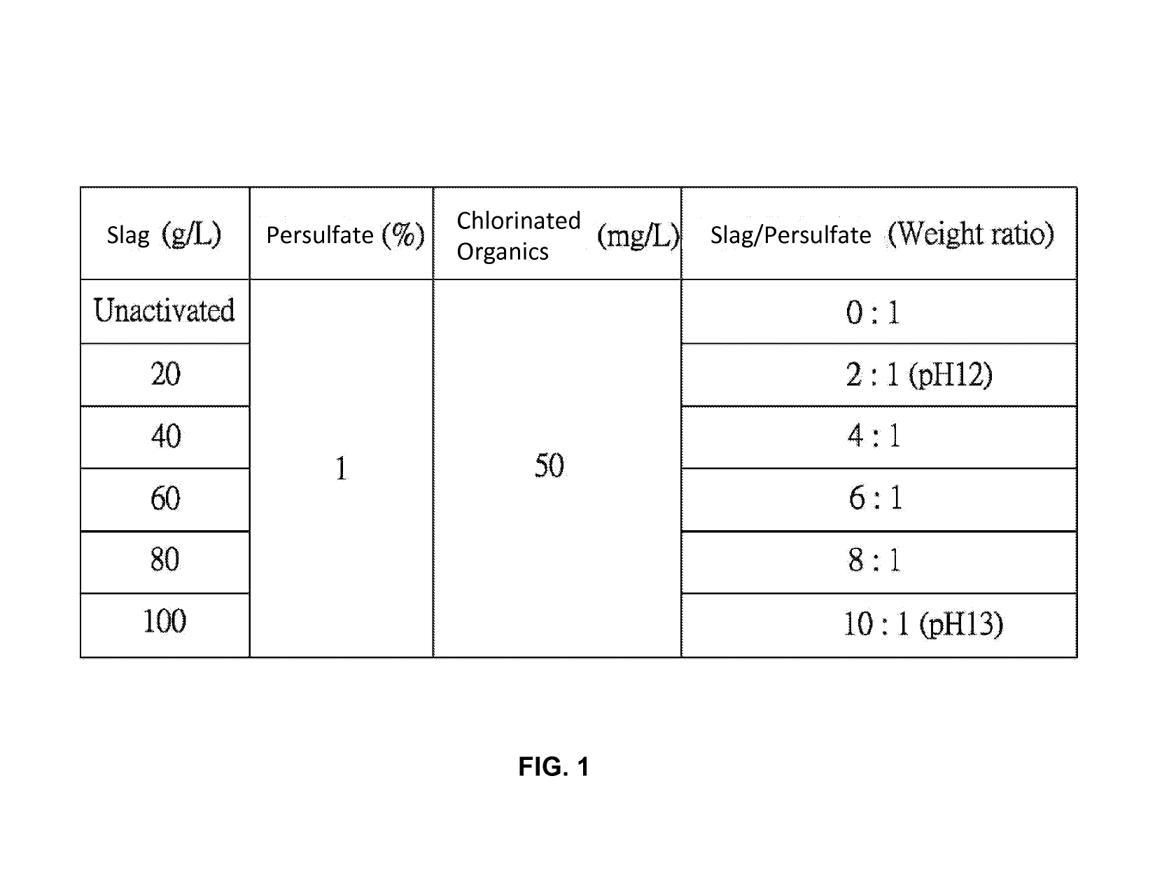

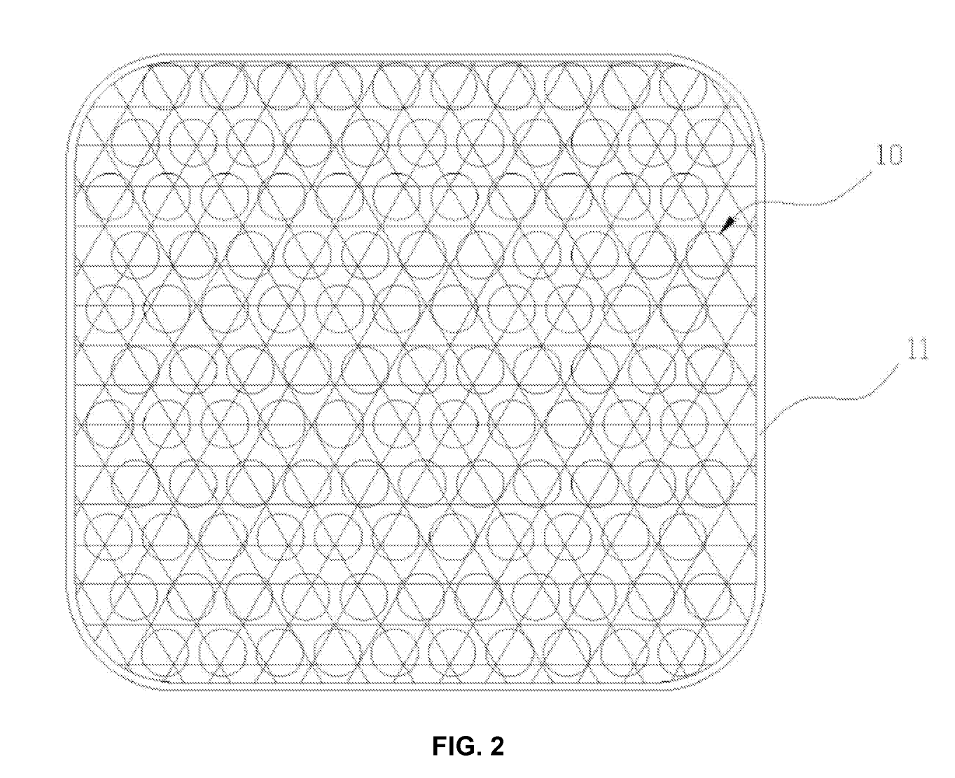

In order to further understand the goal, characteristic and effect of the present invention, a number of embodiments along with the drawings are illustrated as following. Referring to FIG. 1, the present invention is raising pH level to enhance degradation of chlorinated organics by in situ chemical oxidation (ISCO). Adding 1% persulfate and 20-100 g slag to 50 mg/L chlorinated organics, which utilize slag to increase the polluted water pH to 12-13, and make persulfate alkali-activated to enhance the degradation of chlorinated organics and prevent heavy metal pollute the soil. Also referring to FIG. 2, slag 10 can be uniformly released 11 to polluted water, and slag 10 will be took out after degradation oxidative degradation, which can decrease the possibility of secondary pollution.

Wherein the slag is basic oxygen furnace(BOF) or proportional mixing of basic oxygen furnace slag(BOF) and ground granulated blast-furnace slag(GGBS). In order to enhance organochloride degradation, the present invention gets the best slag consumption through result of experiments and monitors polluted water's pH level that can control persulfate alkali-activation rate and oxidation rate. Furthermore, using slag from industrial waste to do alkali-activation can decrease the cost of this invention. The slag contains calcium oxide and dicalcuim silicate, which can raise polluted water's pH level. First, adding 100 g/L slag to 1% persulfate solution and monitoring polluted water's pH level to estimate persulfate alkali-activation. According to the result of experiments, BOF's pH level changes from 12.3 to 12.8 after 86 hours, which proves persulfate does be alkali-activated and increase pH greater than 12. GGBS's pH level changes from 11.1 to 11.8 after 86 hours. Therefore, proportional mixing of BOF and GGBS can increase pH greater than 12, and monitoring 20, 40, 60, 80, 100 g/L persulfate solution get its pH level increase to 12-13.

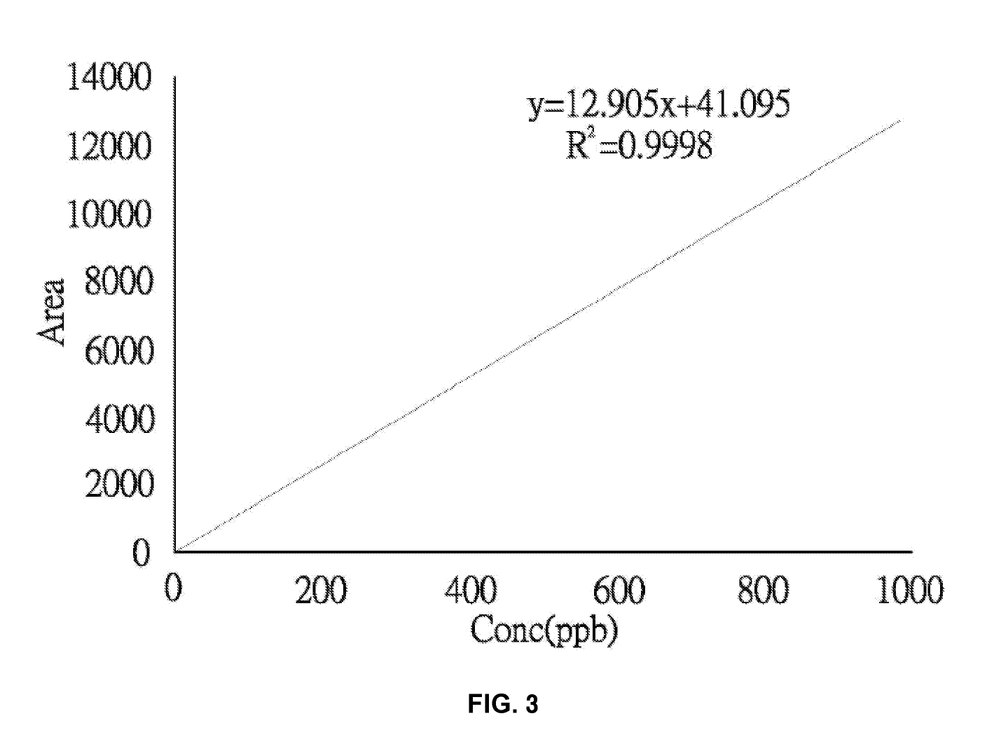

In order to understand the variance of organochloride (1,2-dichloroethane) degradation by alkali-activated persulfate, and feasibility of using slag to alkali-activate persulfate under different pH conditions, we use batch oxidation to explore the influence of alkali-activated persulfate degrades pollutant as the following steps:
1. Prepare 50 mg/L 1,2-dichloroethance solution with 1 L serum bottle and mix it by magnetic stirrer;
2. Add 1% persulfate to polluted water and mix it uniformly;
3. Use dispenser to put polluted water with different quantities (20-100 g) slag to 50 mL reactor and non-slag 50 mL reactor (non-activated);
4. Put it in the oven controlled oscillator; and
5.Analysis pH level, and concentration of persulfate and 1,2-dichlorethane time sampling.

Wherein, 1,2-dichlorine is analyzed by gas chromatography flame ionization detector, (GC/FID) (Agilent 7890A GC). The column is GsBP-624, with length 60 m and inner diameter 0.32 mm. Condition: inject temperature 180° C., detector temperature 230° C., oven temperature 35° C., retention time: 5 min, carry gas is nitrogen (N₂, 99.995%), flow rate: 2.4 mL/min, diversion ration: 1/1, volume of sample injection 10 mL, air-blown time 14 min. 1,2-dichlorethane calibration curve is prepared by specific gravity of samples with different concentration. Referring to FIG. 3, 1,2-dichlorethane's retention time is 11.182 min according to GC-FID.

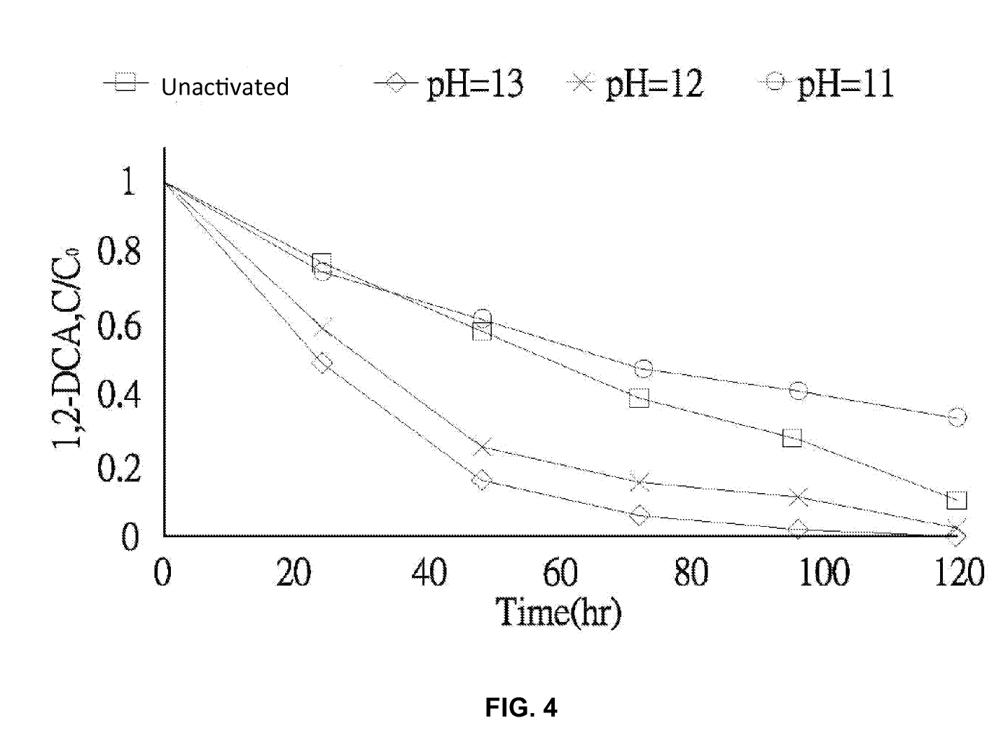

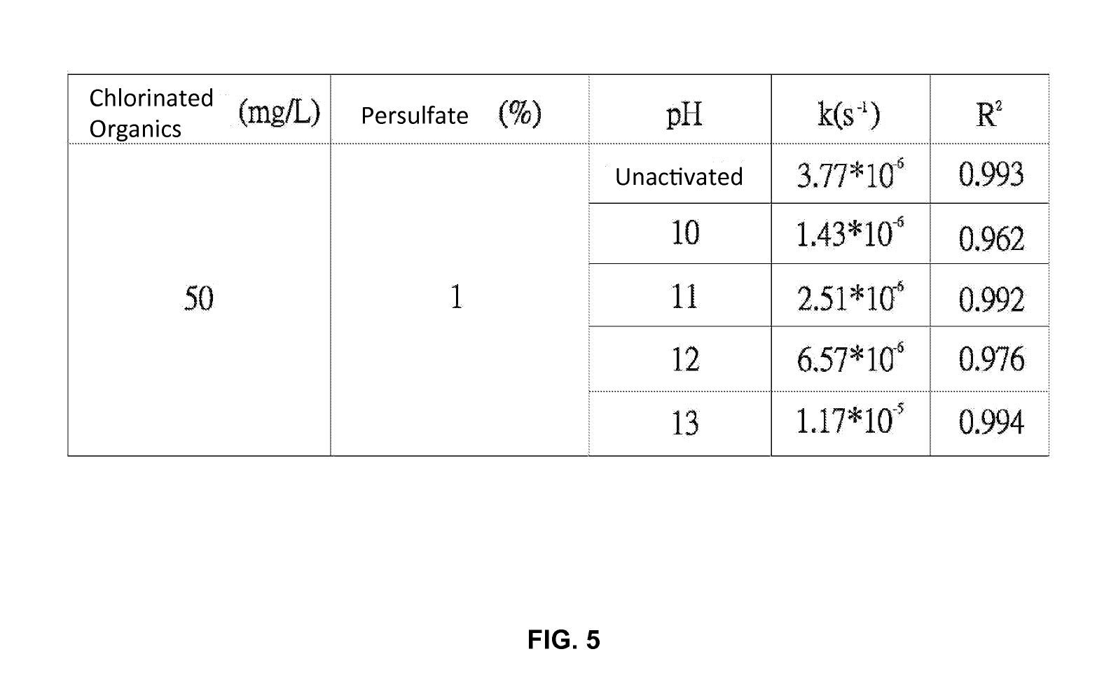

According to the result of experiments and FIG. 4-5, 1,2-dichlorethane degradation rate increase as pH raise, but if pH is under 12, its degradation rate is less than non-activated group. The degradation rate only increase under pH greater than 12. It takes 120 hours to remove 90% 1,2-dichlorethane if persulfate is not alkali-activated, 96 hours to remove 94% 1,2-dichlorethane if persulfate is alkali-activated, and 72 hours to remove 94% to remove 1,2-dichlorethane if persulfate is alkali-activated and under pH 13. Therefore, adding 1% persulfate and 20-100 g slag to 50 mg/L polluted water with chlorinated organics can increase polluted water pH to 12-13 and make persulfate alkali-activated to enhance the degradation of chlorinated organics. Monitoring polluted water's pH level can coordinate different water flow rate, water volume, pollution concentration, and pollution area with proportional mixing of slag and adjust the ratio between persulfate and slag to control pH between 12-13. Whereby, it can increase organochloride degradation, decrease the cost, simple control, eliminate oxidative degradation time and overcome the problems stated above.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A method for raising pH value to enhance degradation of chlorinated organics by oxidation comprising steps of adding 1% persulfate and 20-100 g slag to 50 mg/L chlorinated organics; and utilizing slag to increase the pH to 12-13, so the persulfate is alkali-activated to enhance the degradation of chlorinated organics and prevent heavy metal pollution of the soil.

2. The method for raising pH value to enhance degradation of chlorinated organics by oxidation of claim 1, wherein the persulfate is sodium persulfate.

3. The method for raising pH value to enhance degradation of chlorinated organics by oxidation of claim 1, wherein the slag is basic oxygen furnace slag.

4. The method for raising pH value to enhance degradation of chlorinated organics by oxidation of claim 1, wherein the slag is a mixture of basic oxygen furnace slag and ground granulated blast-furnace slag.

5. The method for raising pH value to enhance degradation of chlorinated organics by oxidation of claim 1, wherein the chlorinated organics is 1,2-dichloroethane, 90% of which is removed after 96 hours by persulfate alkali activation at pH 12, and 94% of which is removed after 72 hours by persulfate alkali activation at pH 13.

6. The method for raising pH value to enhance degradation of chlorinated organics by oxidation of claim 1, wherein the slag is uniformly released to polluted water and taken out after degradation oxidative reaction to reduce the possibility of secondary pollution.
